(19) United States
(12) Patent Application Publication
(10) Pub. No.: US 2008/0255909 A1
(43) Pub. Date: Oct. 16, 2008

(54) PRODUCT, METHOD AND SYSTEM FOR DYNAMICALLY CHANGING THE EXECUTION SEQUENCE OF STEPS OR TASKS IN A COMPUTERIZED PROCESS

(75) Inventors: Niraj P. Joshi, Cary, NC (US); Kimberly Diane Kenna, Cary, NC (US); Kenneth James Parzygnat, Apex, NC (US); Chakkalamattam Jos Paul, Austin, TX (US); Wayne B. Riley, Cary, NC (US)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 11/735,374

(22) Filed: Apr. 13, 2007

(51) Int. Cl. G06F 9/46

(52) U.S. Cl. 705/8

(57) ABSTRACT

An invention is disclosed for dynamically changing the predefined execution sequence of steps or tasks in a computerized process while it is being performed by permitting one or more task(s) to be specified as necessary when other task(s) have been completed. Specifically, a product, method and system is provided for using a “workflow engine” software program acting in combination with a “decision-making layer” program interface between the workflow engine and the process model to determine the normal or (“default”) next step in the process and all other possible process steps that can be permissibly completed after execution of the current step or task.

### TECHNICAL FIELD

This invention relates to use of “workflow engine” computer software programs in modeling production or service work processes.

### BACKGROUND

“Workflow engine” computer software programs are gaining popularity as organizations become interested in predefining (or “modeling”) manufacturing or other production or service work processes to make them repeatable and monitorable for quality control purposes. Workflow engines apply the model definition of a process to manually lead a user (and/or drive an automated system) through the various steps or tasks required to complete the process. As one task is completed, the workflow engine examines (or “reads”) the process model definition to obtain and dispatch the next predefined task for either manual or automated completion.

The problem addressed by this invention is that process models do not always allow for dynamic (i.e., “as needed”) changes in the predefined task flows to occur as a process is executed. To further complicate the problem, it is often desired to allow adjustments to the task flow to dynamically occur in “real time” after completion of any one or more steps in the process. Typical solutions to this problem involve building extremely complex BPEL (Business Process Execution Language) models where the multitude of possible paths of process execution (i.e., “task flows” or “branches”) are all predefined, ultimately resulting in a process model that isn't usable or maintainable. Another solution to this problem is to manually (or programmatically) designate certain tasks to be skipped as “complete” before allowing the workflow engine to progress to the next desired task, which wastes processing time and potentially lengthens the time that a user must await identification of the next task to be performed.

The invention solves this problem by providing the ability to redefine and/or circumvent the usual execution sequence of steps or tasks in a process in allowing the predefined task flow to be dynamically changed while the process is being performed. Providing this capability simplifies process model creation and maintenance and permits performance of a BPEL process to assume greater flexibility by allowing each individual execution of the process to potentially take a different sequence path through the process.

### SUMMARY OF THE INVENTION

An invention is provided for dynamically changing the predefined execution sequence of steps or tasks in a computerized process (while it is being performed) by permitting one or more selected task(s) to be performed as necessary when other task(s) have been completed. Specifically, a product, method and system is provided for using a “workflow engine” software program acting in combination with a “decision-making layer” program interface between the workflow engine and the process model to determine the normal or (“default”) next step in the process and all other possible valid process steps that can be completed after execution of the current step or task instead of (or in addition to) the predefined next step in the process model. This “decision-making point” can occur at any or all steps in the process and is dependent upon information acquired during “real-time” performance of one or more process tasks; and the specification of process task(s) to be performed can be determined by the workflow engine program without user intervention or via a user interface presenting a selection of possible valid (i.e., permissible) subsequent tasks based upon information gathered during performance of current and/or previous task(s).

In operation, the invention changes the flow of “workflow engine” control between executed process steps or tasks based upon information first obtained in performing a given task that makes it necessary to decide whether to (a) repeat one or more previously completed step(s) or task(s) in the process; and/or to (b) skip one or more subsequent process step(s) or task(s) (without performing the skipped step(s) or task(s)); and/or to (c) complete the process by skipping all remaining steps and tasks.

It is therefore an object of the present invention to provide the ability to change the predefined execution sequence of steps or tasks in a computerized process by permitting selected task(s) to be performed when other task(s) have been completed.

It is another object of the present invention to provide a product, method and system for using a “workflow engine” software program acting in combination with a “decision-making layer” program interface to determine the normal or (“default”) next step in a process and any other process steps that can be permissibly completed after execution of the current step or task instead of or in addition to the next step.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 illustrates the components of a “workflow engine” computer software program according to the invention.

FIGS. 2-4 illustrate flowcharts outlining operation of a “workflow engine” computer software program according to the invention.

FIG. 5 illustrates a graphical user interface (GUI) for a “workflow engine” computer software program according to the invention.

### DETAILED DESCRIPTION OF THE PREFERRED EMBODIMENTS

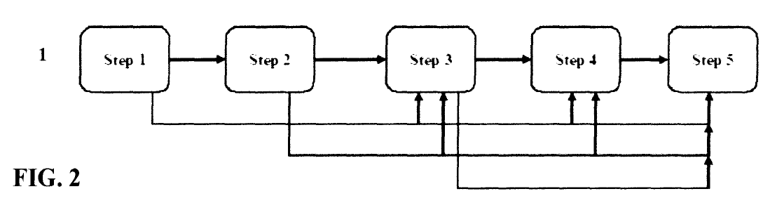

FIG. 2 illustrates an example process model containing five predefined steps (ordinarily performed “by default” as Step “1” & “2” & “3” & “4” & “5”) where it is permissible to skip one or more of those steps while still arriving at a valid final result upon completion of the process. To handle this situation, prior art process models must predetermine the “linkage” (i.e., all possible permutations and/or combinations) leading from each executed process step to any permissible subsequent process step(s) while allowing for the skipping of steps as necessary. This results in very complicated workflow engine programming to implement the process model, and adding a new step to the process potentially requires adjustments to the model (and its implementation) for any or all of the existing process steps.

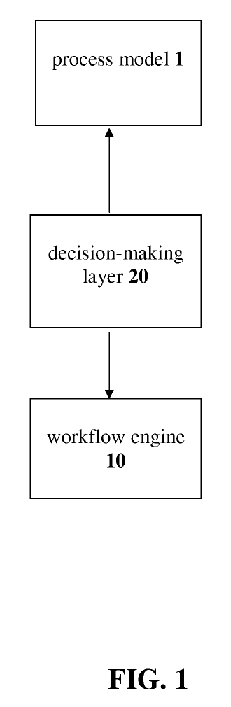

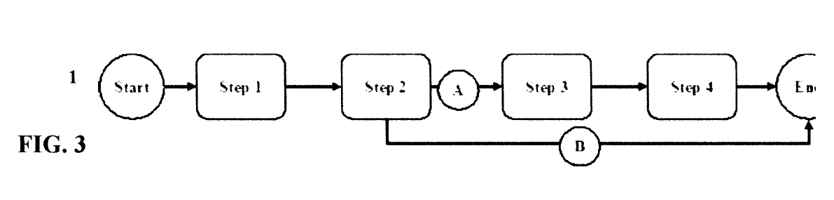

As illustrated in FIG. 1, a preferred embodiment of the invention solves this problem by modifying the “workflow engine” software 10 and/or by adding a “decision-making layer” program 20 to interface between the workflow engine 10 and the process model 1 (using conventional object-oriented or other programming techniques) to determine the normal or (“default”) next step in the process and all other possible valid process steps that can be permissibly completed either alone or in any combination after execution of the current step or task. As each task is completed, the process model 1 is dynamically examined by the “decision-making layer” 20 to determine the next step as specified by the model (i.e. the “default next step”) and then to obtain a list of all permissible subsequent steps that can be performed instead of or in addition to the next step, along with their order of performance. The “decision-making layer” 20 is invoked as each task is started and returns a result to the workflow engine 10 as that task is completed, whereby it automatically interrogates the process model 1 to provide the user with a list of permissible next tasks and/or combinations thereof that can be validly performed upon completion of the current prerequisite task. FIG. 3 illustrates this in showing the predefined task flow path through the process 1 as indicated by “A” (i.e., sequential execution of Steps “1” through “4”) but the process can be designated as complete after execution of Step “2” (i.e., path “B”) if it is determined (upon execution) that performance of Steps “3” and “4” is unnecessary for this particular instance of the process.

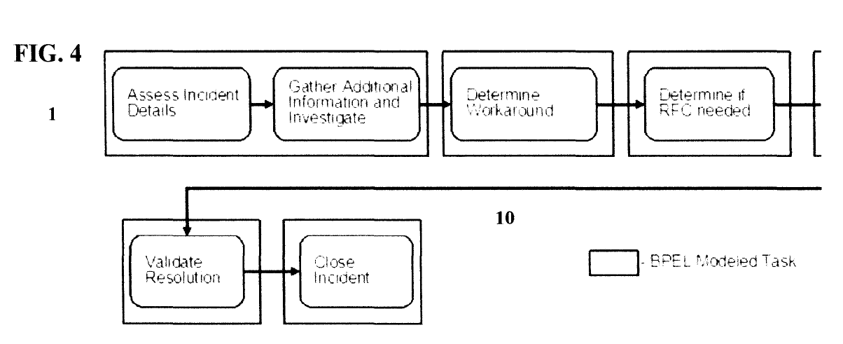

As illustrated in the example of FIG. 4, many criteria are evaluated for a given task to be returned by the “decision-making layer” as a permissible next task including whether (a) it is a subsequent task in the predefined process model (including a task that was previously completed and can be repeated as needed by the process); (b) valid input data for the task is available (if required); (c) any intermediary task(s) are required between performance of the current prerequisite task(s) and the potential subsequent task(s); and (d) rules govern permission to move the process to task(s) other than the predefined “default” next task. For example, if a computer ordering process specifies an “approval” task between allowing a customer to “submit an order” for a new computer and a task for that order to be “processed” (whereby it is not permissible to skip the “approval” task) then the “approval” task is indicated as required and the “order processing” task cannot be returned by the “decision-making layer” as an available next step to be performed immediately following the “submit order” task.

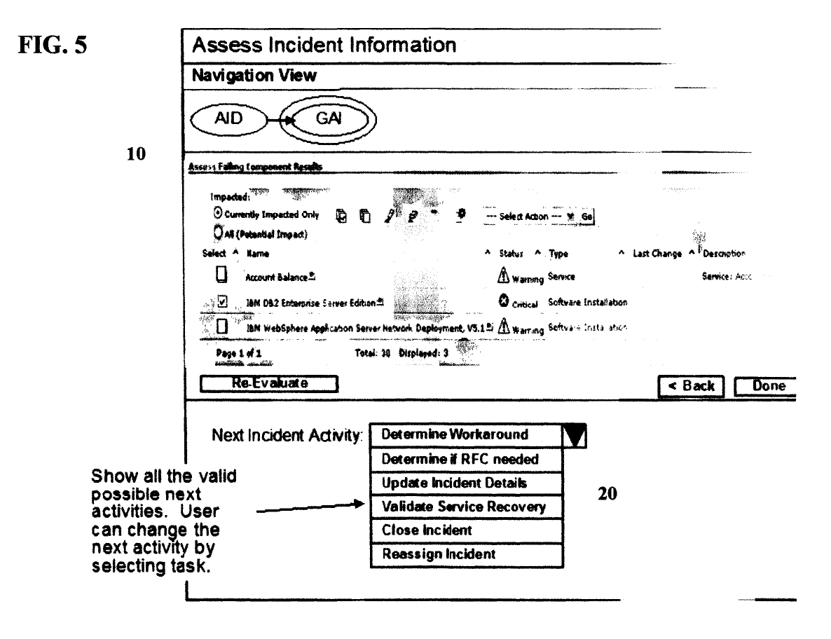

As illustrated in FIG. 5, once the list of permissible next tasks is returned by the “decision-making layer” 20 to the workflow engine 10 via an application programming interface (API), the graphical user interface (GUI) component of the software shows the result and provides control of the process 1 to the user (for example via a “drop down” menu list allowing selection of any of the listed permissible tasks). This list can be shown to indicate that the prerequisite task(s) have been completed, and can contain features allowing the user to optionally choose one or more of the permissible new task(s) and/or “skip over” execution of the predefined “default” task as the next sequential step in the process. If the user selects different permissible task(s) (other than the “default” next step) then the “decision-making layer” 20 instructs the workflow engine 10 to move ahead to processing of the selected task(s) instead of the “default” step. The skipping of intermediate tasks can be recorded and the user is presented with the GUI for the next chosen task (if assigned). Marking steps that have been skipped allows them to be displayed and reported later when evaluating the efficiency and value of the different steps in a given process.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system for changing the predefined execution sequence of steps or tasks in a process and comprised of at least the following software components containing program instructions executed by the computer system to permit one or more selected process tasks to be performed as necessary when one or more other tasks have been completed:
(a). a workflow engine configured for examining a process model to specify the next task for manual or automated completion; and
(b). a decision-making program interface configured to act in combination with the workflow engine and the process model to determine:
(i). the next step normally executed in the process; and
(ii). any other process step permitted for execution after the current step instead of or in addition to the next step;
wherein the decision-making interface is invoked to select a process step dependent upon information acquired during performance of one or more other process tasks.

2. The computer system of claim 1 wherein the workflow engine changes the process execution sequence by:
(a). repeating one or more process steps; or
(b). skipping one or more process steps; or
(c). completing the process by skipping all remaining steps.

3. The computer system of claim 1 wherein the decision-making interface determines if a process step is permitted for execution based on whether:
(a). that step is a subsequent task in the process model; or
(b). valid input data is available for that task; or
(c). performance of an intermediate task is required; or
(d). rules govern permission to move the process to that task.

4. The computer system of claim 1 wherein specification of a process task for completion is determined by the workflow engine without user intervention.

5. The computer system of claim 1 wherein a user interface presents a selection of process tasks to a user for performance.

6. The computer system of claim 2 wherein a skipped process step is recorded.

7. A method of using a computer system for changing the predefined execution sequence of steps or tasks in a process and comprised of at least the following steps carried out by the following software components containing program instructions executed by the computer system to permit one or more selected process tasks to be performed as necessary when one or more other tasks have been completed:
(a). configuring a workflow engine for examining a process model to specify the next task for manual or automated completion; and
(b). configuring a decision-making program interface to act in combination with the workflow engine and the process model to determine:
(i). the next step normally executed in the process; and
(ii). any other process step permitted for execution after the current step instead of or in addition to the next step;
wherein the decision-making interface is invoked to select a process step dependent upon information acquired during performance of one or more other process tasks.

8. The method of claim 7 wherein the workflow engine changes the process execution sequence by:
(a). repeating one or more process steps; or
(b). skipping one or more process steps; or
(c). completing the process by skipping all remaining steps.

9. The method of claim 7 wherein the decision-making interface determines if a process step is permitted for execution based on whether:
(a). that step is a subsequent task in the process model; or
(b). valid input data is available for that task; or
(c). performance of an intermediate task is required; or
(d). rules govern permission to move the process to that task.

10. The method of claim 7 wherein specification of a process task for completion is determined by the workflow engine without user intervention.

11. The method of claim 7 wherein a user interface presents a selection of process tasks to a user for performance.

12. The method of claim 8 wherein a skipped process step is recorded.

13. A computer product used with a computer system for changing the predefined execution sequence of steps or tasks in a process and comprised of a computer readable storage medium containing program instructions executed by at least the following software components of the computer system to permit one or more selected process tasks to be performed as necessary when one or more other tasks have been completed:
(a). a workflow engine configured for examining a process model to specify the next task for manual or automated completion; and
(b). a decision-making program interface configured to act in combination with the workflow engine and the process model to determine:
(i). the next step normally executed in the process; and
(ii). any other process step permitted for execution after the current step instead of or in addition to the next step;
wherein the decision-making interface is invoked to select a process step dependent upon information acquired during performance of one or more other process tasks.

14. The computer product of claim 13 wherein the workflow engine changes the process execution sequence by:
(a). repeating one or more process steps; or
(b). skipping one or more process steps; or
(c). completing the process by skipping all remaining steps.

15. The computer product of claim 13 wherein the decision-making interface determines if a process step is permitted for execution based on whether:
(a). that step is a subsequent task in the process model; or
(b). valid input data is available for that task; or
(c). performance of an intermediate task is required; or
(d). rules govern permission to move the process to that task.

16. The computer product of claim 13 wherein specification of a process task for completion is determined by the workflow engine without user intervention.

17. The computer product of claim 13 wherein a user interface presents a selection of process tasks to a user for performance.

18. The computer product of claim 14 wherein a skipped process step is recorded.
